(19) United States
(12) Patent Application Publication
(10) Pub. No.: US 2006/0243145 A1
(43) Pub. Date: Nov. 2, 2006

(54) Printing press and method for operating the same

(75) Inventors: Jens Hieronymus, Darmstadt (DE); Jurgen Michels, Dossenheim (DE); Dieter Schaffrath, Lorsch (DE); Wolfgang Schonberger, Schriesheim (DE); Bernhard Schwaab, Neustadt (DE); Michael Thielemann, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen Aktiengesellschaft

(21) Appl. No.: 11/415,052

(22) Filed: May 1, 2006

(30) Foreign Application Priority Data
Apr. 29, 2005 (DE) 10 2005 019 910.0

(51) Int. Cl. B41M 1/14

(52) U.S. Cl. 101/211

(57) ABSTRACT

A method for operating a printing press having a printing form cylinder and a screen roller, includes rotating the printing form cylinder in a first direction of rotation and rotating the screen roller at the same time, during a continuous printing operation. The printing form cylinder is rotated in a second direction of rotation and the screen roller is kept at a rotational standstill at the same time, during an interruption in the printing operation. A printing press for carrying out the method has a clutch, preferably a freewheeling clutch, integrated into an anilox inking unit having the screen roller, in such a way that the clutch stops the rotation of the screen roller during reverse running of the printing press.

### BACKGROUND OF THE INVENTION

### Field of the Invention

The present invention relates to a printing press having a screen roller and to a method for operating such a printing press.

In German Published, Non-Prosecuted Patent Application DE 101 44 563 A1, corresponding to U.S. Pat. No. 6,745,689 B2, a printing press having a screen roller is shown, on which there rests a chamber-type doctor that includes a negative metering doctor and a positive metering doctor, which seal off a chamber of the chamber-type doctor at the top and bottom. The advantage of that chamber-type doctor is that it permits rotation of the screen roller in an opposite direction of rotation with respect to printing operation without the risk of conveying excess ink out of the chamber. The disadvantage of the chamber-type doctor is to be seen in its poorer ability to be cleaned and its higher number of parts subject to wear. The parts of the chamber-type doctor which are subject to wear are the positive metering doctor and the negative metering doctor.

In German Published, Non-Prosecuted Patent Application DE 102 03 695 A1, corresponding to U.S. Pat. No. 6,705,223 B2, a printing press having a screen roller is likewise shown. On that screen roller there rests an ink feed device, which is constructed as a trough-like ink container open at the top and having a single metering doctor fitted thereto. The advantage of that ink feed device is to be seen in its good ability to be cleaned and its low number of parts subject to wear. The single metering doctor is the single part of the ink feed device which is subject to wear and has to be replaced regularly by a new one. The disadvantage of the ink feed device is that, during rotation of the screen roller in an opposite direction of rotation with respect to the printing operation, printing ink adhering to the screen roller in lumps is conveyed out of the ink container and, as excess ink, is conveyed into the section of the anilox inking unit following the screen roller. That cannot be avoided in the case of that ink feed device having only a single metering doctor and, accordingly, being open at the top, as opposed to the chamber-type doctor. However, running the printing press in reverse is necessary for various maintenance operations.

### SUMMARY OF THE INVENTION

It is accordingly an object of the invention to provide a printing press and a method for operating the same, which overcome the hereinafore-mentioned disadvantages of the heretofore-known devices and methods of this general type and which permit both a good ability to clean an inking unit and a good ability to maintain the printing press.

With the foregoing and other objects in view there is provided, in accordance with the invention, a method for operating a printing press having a printing form cylinder and a screen roller. The method comprises rotating the printing form cylinder in a first direction of rotation and rotating the screen roller at the same time, during a continuous printing operation. The printing form cylinder is rotated in a second direction of rotation and the screen roller is maintained at a rotational standstill at the same time, during an interruption in the printing operation.

This method permits the use of an ink feed device which is open at the top and has a single metering doctor, and it is possible for such an ink feed device to be cleaned particularly easily. Nevertheless, during reverse running of the printing press which, for example, is required in order to carry out maintenance operations, during which the printing form cylinder rotates in the second direction, there is no risk of conveying excess printing ink not metered by the metering doctor into the inking unit section following the screen roller.

In accordance with another mode of the invention, the metering doctor is kept set against the screen roller during the interruption to the printing operation.

With the objects of the invention in view, there is also provided a printing press, in particular for carrying out the method of the invention. The printing press comprises an anilox inking unit with a screen roller and a clutch integrated into the anilox inking unit. The clutch stops rotation of the screen roller during reverse running of the printing press.

In accordance with another feature of the invention, the clutch is a controllable clutch.

In accordance with a further feature of the invention, the screen roller is connected by the clutch to a gear which is disposed coaxially with the screen roller.

In accordance with an added feature of the invention, the anilox inking unit includes a roller which, during the continuous printing operation, rests on the screen roller and is coaxially associated with a gear. The screen roller is coaxially associated with a further gear and the two gears—the one associated coaxially with the roller and the one associated coaxially with the screen roller—are connected to each other by a gear mechanism. The clutch is integrated into the gear mechanism.

In accordance with an additional feature of the invention, the gear mechanism can be formed in such a way that, during forward running of the printing press, the roller and the screen roller rotate in a manner coordinated with each other such that, after each full rotation of the screen roller, a pattern formed of fresh accumulations of printing ink and applied to the roller by the screen roller has such a slight offset in the circumferential roller direction with respect to just such a pattern that has been applied to the roller by the screen roller during the preceding full revolution of the latter and is formed of accumulations of printing ink residues, that the fresh accumulations of printing ink are deliberately placed in gaps substantially free of printing ink between respective adjacent accumulations of printing ink residues on the roller.

In accordance with yet another feature of the invention, there is provided an ink feed device having a single doctor resting on the screen roller.

In accordance with yet a further feature of the invention, the clutch is a freewheeling clutch. The integration of the freewheeling clutch into the anilox inking unit is a technical measure which simplifies the ability to operate the printing press. The rotational standstill of the screen roller required during reverse running of the printing press is necessarily ensured by the freewheeling clutch and without any operating actions by the operator.

In accordance with yet an added feature of the invention, there is provided an auxiliary motor integrated into the anilox inking unit in order to rotate the screen roller during the rotational standstill of a printing form cylinder.

In accordance with yet an additional feature of the invention, there is provided a further clutch integrated into the anilox inking unit in such a way that, during continuous printing operation, the further clutch prevents the transmission of a main driving gear mechanism movement to the auxiliary motor. The main driving gear mechanism movement is the movement of a gear mechanism of the printing press which is effected by the main drive of the printing press.

In accordance with a concomitant feature of the invention, the further clutch is a freewheeling clutch.

Other features which are considered as characteristic for the invention are set forth in the appended claims.

Although the invention is illustrated and described herein as embodied in a printing press and a method for operating the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, side-elevational view of a first exemplary embodiment of the invention;

FIG. 1B is a fragmentary, partly broken-away, end-elevational view of the first exemplary embodiment of the invention; and

FIGS. 2A and 2B are views similar to FIGS. 1a and 1b, respectively, of a second exemplary embodiment of the invention.

### DESCRIPTION OF THE PREFERRED EMBODIMENTS

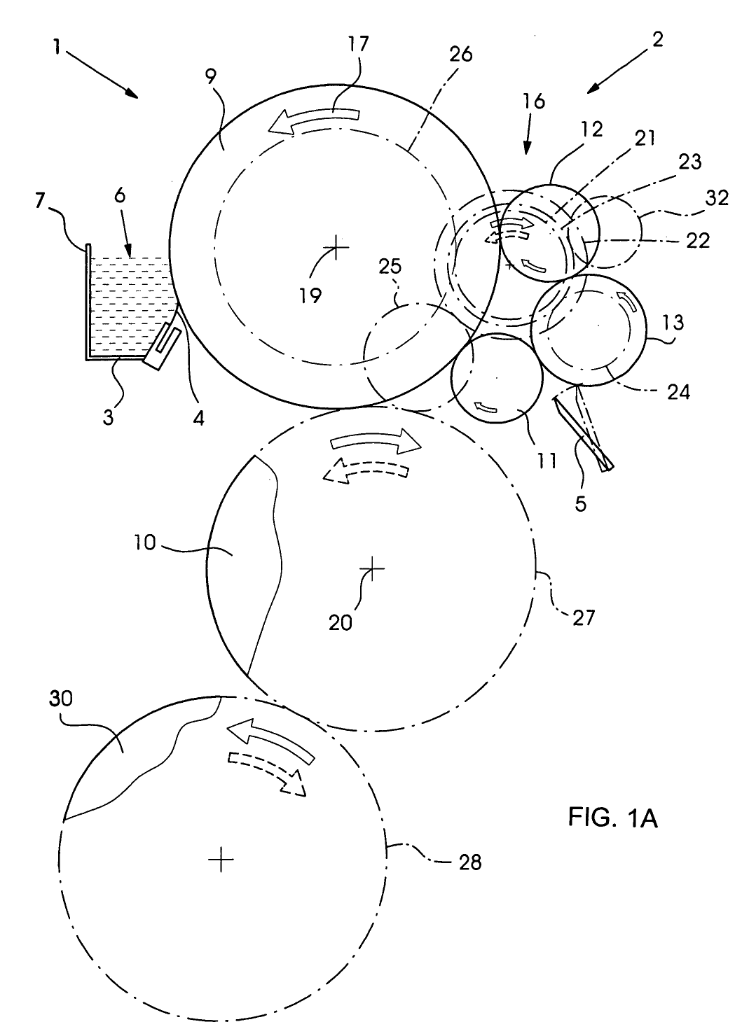

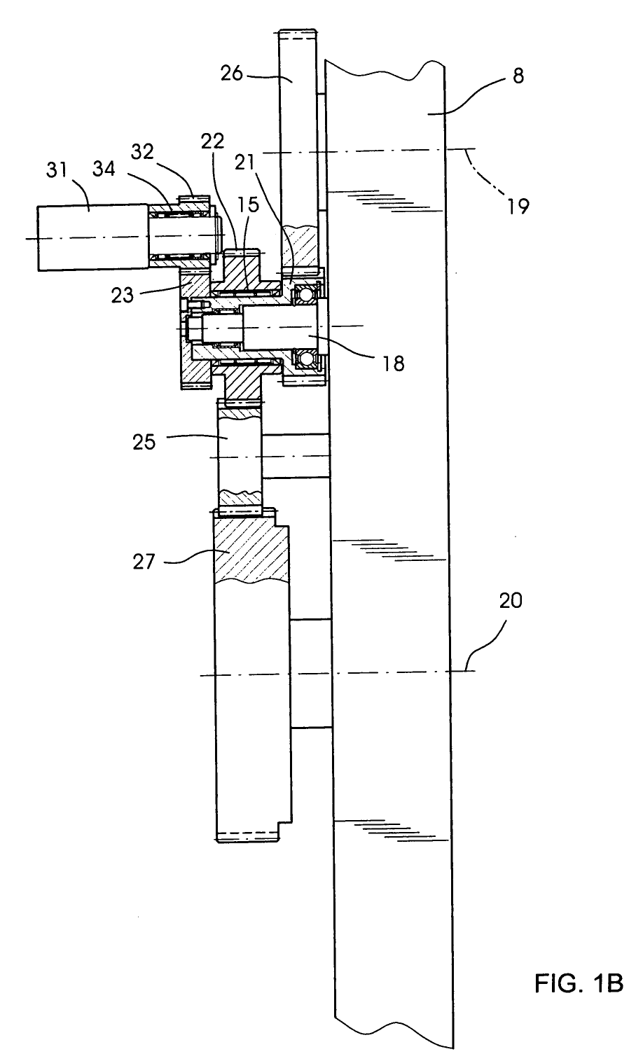

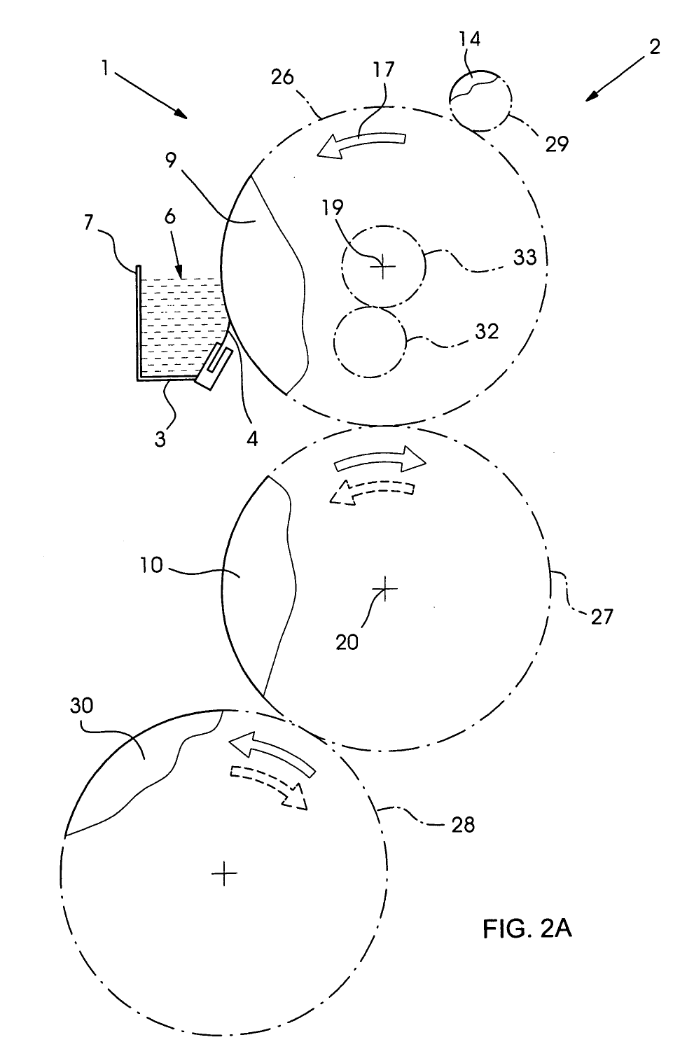

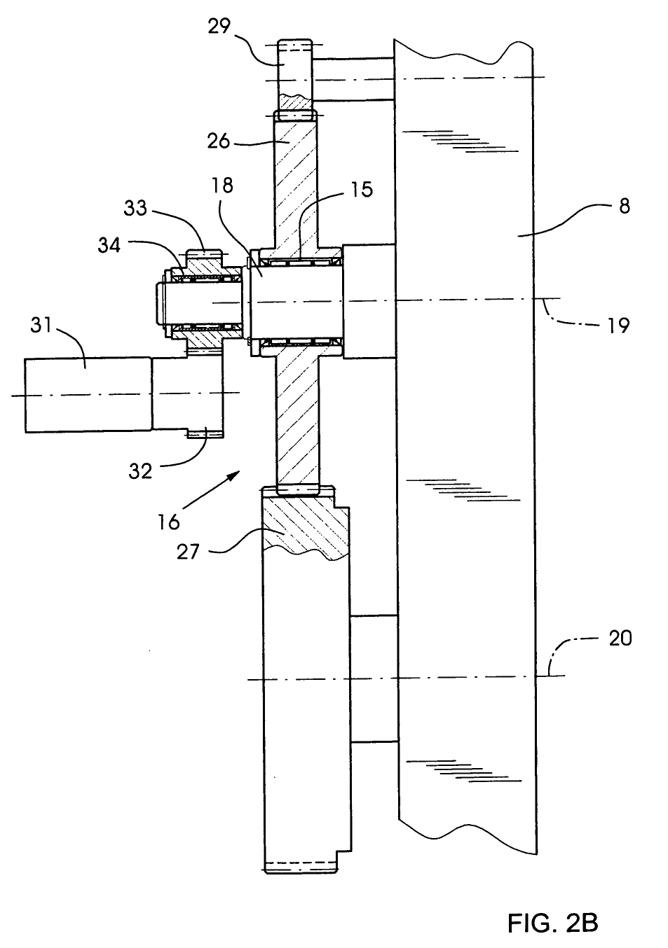

Referring now in detail to the first and second embodiments of FIGS. 1A, 1B, 2A and 2B of the drawings, in which mutually corresponding elements and components are designated by the same reference symbols, there is seen in each case a printing press 1 for lithographic offset printing. The respective printing press 1 includes a printing form cylinder 30, an anilox inking unit 2 which includes a screen, engraved or anilox roller 9 having a geometric screen roller axis of rotation 19, and an applicator roller 10 having a geometric applicator roller axis of rotation 20. The applicator roller 10 is in rolling contact with the screen roller 9 and, during printing operation, is also in rolling contact with the printing form cylinder 30.

An ink feed device, which is set against the screen roller 9, is different from a chamber-type doctor and includes an ink container 3 having a metering doctor 4. The metering doctor 4 is a single metering doctor of the ink feed device and is set negatively against the screen roller 9 with respect to a direction of rotation 17 of the latter occurring during printing operation. The ink feed device therefore includes neither negative doctors nor a positive doctor.

Printing ink in the ink container 3 forms an ink level 6 which, during printing operation, lies above a cutting edge of the metering doctor 4 resting on the screen roller 9. In order to be able to lower the ink level 6 to a height located underneath this cutting edge and to be able to set the ink feed device of the screen roller 9 without the risk of the printing ink running out of the ink container 3, the ink container 3 is provided with a displaceable rear wall 7, which functions as a displacement element for the optional raising and lowering of the ink level 6. The ink container 3 and its displaceable rear wall 7 are disclosed in detail in German Published, Non-Prosecuted Patent Application DE 102 03 695 A1, corresponding to U.S. Pat. No. 6,705,223 B2. FIGS. 1 to 3 and associated descriptions contained in that patent are therefore incorporated by reference into the present disclosure.

The printing presses 1 illustrated in FIGS. 1A to 2B have the following common features: the screen roller 9, the applicator roller 10 and the printing form cylinder 30 driven in rotation by a non-illustrated electric motor, which is what is known as a main drive of the printing press 1. To this end, a gear 28 is disposed coaxially with the printing form cylinder 30 and is connected firmly to the latter so as to rotate therewith. The gear 28 is designated an an eighth gear in the following text and meshes with a gear 27 which is disposed coaxially with the applicator roller 10 and connected firmly to the latter so as to rotate therewith. The gear 27 is designated as a seventh gear in the following text.

A gear 26, which is disposed coaxially with the screen roller 9, will be designated as a sixth gear in the following text. The seventh gear 27 is coupled directly (see FIGS. 1A and 1B) or indirectly (see FIGS. 2A and 2B) to the sixth gear 26 in such a way that rotational drive movement or torque is transmitted from the former to the latter. The gears 26, 27, 28, the rollers 9, 10 and the printing form cylinder 30 are mounted between side walls 8 of a machine frame, one of which is shown in the drawing.

In the exemplary embodiment shown in FIGS. 1A and 1B, the sixth gear 26 is firmly connected to the screen roller 9 so as to rotate therewith. A first roller 11 and a second roller 12 rest on the screen roller 9 and a third roller 13 rests on the first and second rollers 11, 12. The rotations of the first and second rollers 11, 12 are driven exclusively by circumferential roller surface friction. The third roller 13 is an axially oscillating distributor roller. A cleaning doctor 5 for cleaning the anilox inking unit 2, which is carried out after the printing operation, is disposed in such a way that it can be set against the third roller 13 and set off the latter again.

A first gear 21, a second gear 22 and a third gear 23 are seated on a common axle or shaft 18. The first gear 21 and the third gear 23 are connected firmly so as to rotate with each other. The second gear 22 is mounted on the first gear 21, or an extension of the first gear 21, through a freewheeling clutch 15. A fourth gear 24 is disposed coaxially with the third roller 13 and firmly connected so as to rotate with the latter. A fifth gear 25 is rotatably mounted in the side wall 8. The first gear 21 meshes with the sixth gear 26. The fifth gear 25 meshes with the second gear 22 and the seventh gear 27. The third gear 23 meshes with the fourth gear 24. All of the gears 21 to 28 are externally toothed. The axle or shaft 18 in the first exemplary embodiment is a fixed axle or shaft.

The rotational drive movement is transmitted from the seventh gear 27 to the fifth gear 25 and from the latter to the second gear 22. In this case, during printing operation, the second gear 22, the printing form cylinder 30 together with the eighth gear 28, and the applicator roller 10 together with the seventh gear 27 rotate in the directions of rotation which are indicated in FIG. 1A by arrow symbols illustrated with a continuous line. In addition, during printing operation, the second gear 22 rotates in a direction of rotation which results in the freewheeling clutch 15 locking and transmitting the rotational drive movement from the second gear 22 to the first gear 21 and thus to the third gear 23. The rotational drive movement is further transmitted from the third gear 23 to the fourth gear 24 and thus to the third roller 13, and is transmitted further from the first gear 21 to the sixth gear 26 and thus to the screen roller 9, which consequently rotates in the direction of rotation 17 indicated by the arrow in FIG. 1A. The first, second and fifth gears 21, 22, 25 together form a gear mechanism 16 for transmitting the rotational drive movement from the seventh gear 27 of the applicator roller 10 to the sixth gear 26 of the screen roller 9.

The transmission ratio of this gear mechanism 16 and the diameters of the screen roller 9 and the applicator roller 10 are chosen in such a way that these two rollers 9, 10 roller on each other without a circumferential surface speed difference and, after each complete revolution of the applicator roller 10, a pattern on the latter of accumulations of printing ink residues that have remained has a circumferential direction offset relative to the respectively preceding roller revolution such that the fresh accumulations of printing ink are placed by the screen roller 9 in gaps substantially free of printing ink between the accumulations of printing ink residues.

This gear mechanism characteristic (effecting the offset) is described in detail in German Published, Non-Prosecuted Patent Application DE 101 44 563 A1, corresponding to U.S. Pat. No. 6,745,689 B2, for which reason the disclosure given textually and by drawing in that patent with respect to this gear mechanism characteristic, including FIG. 1 of German Published, Non-Prosecuted Patent Application DE 101 44 563 A1 or U.S. Pat. No. 6,745,689 B2, is hereby incorporated by reference in the present description. The gears 21, 22, 25 shown in FIGS. 1A and 1B therefore effect the aforesaid offset of the fresh accumulation of printing ink relative to the accumulations of printing ink residues, just like the gears 29, 31, 35, 37 shown in FIG. 2 of German Published, Non-Prosecuted Patent Application DE 101 44 563 A1 or U.S. Pat. No. 6,745,689 B2.

The freewheeling clutch 15 integrated into the gear mechanism 16 effects a change in direction of rotation, after which the second gear 22, the printing form cylinder 30 together with its eighth gear 28 and the applicator roller 10 together with its seventh gear 27 rotate in the directions of rotation which are indicated in FIG. 1 by arrow symbols illustrated by broken lines, a rotational standstill of the screen roller 9 and its sixth gear 26. The screen roller 9 and the sixth gear 26 are not capable of rotating counter to their direction of rotation 17. Such a rotation is prevented by the freewheeling clutch 15 which, during the rotation of the second gear 22 carried out in the direction of rotation which is indicated in FIG. 1A by the arrow symbol illustrated with a broken line, freewheels, so that the rotational drive movement is not transmitted from the second gear 22 to the first gear 21.

The change in the direction of rotation, i.e. what is known as reverse running of the printing press 1, is required for maintenance operations, for example for a change of the rubber blanket clamped on a non-illustrated blanket cylinder or for pressure adjustment in the printing unit or for removal of double sheets or damaged printing sheets from the printing press 1, carried out in the event of plugs, jams or blockages.

Since, during the reverse running of the printing press 1, the screen roller 9 does not corotate, the metering doctor 4 can remain set against the screen roller 9 during the maintenance operations and the associated reverse running. The risk that, as a result of the reverse running, an excess of printing ink adhering to the screen rolled 9 in lumps and not stripped off by the metering doctor 4 will be conveyed out of the ink container 3 by the screen roller 9 and into the following section of the anilox inking unit 2 and lead to printing problems when the printing operation is resumed, does not exist, due to the stoppage of the screen roller 9 effected by the freewheeling clutch 15. During the reverse running, the first roller 11, the second roller 12 and the third roller 13 are likewise at a rotational standstill and the applicator roller 10 is set circumferentially slightly off the screen roller 9 in such a way that the tooth engagement existing between the fifth gear 25 and the seventh gear 27 is maintained.

In the exemplary embodiment shown in FIGS. 2A and 2B, the sixth gear 26 is not coupled to the seventh gear 27 through gears but directly, and the sixth and seventh gears 26, 27 are in mutual tooth engagement. The freewheeling clutch 15 is disposed between the sixth gear 26 and the axle or shaft 18, which in this case is a drive shaft in the form of an axle journal of the screen roller 9 and, just as in the exemplary embodiment shown in FIGS. 1A and 1B, effects a stoppage of the screen roller 9 during the reverse running of the printing press 1, which is indicated by arrow symbols illustrated with an interrupted line in FIG. 2A. Thus, the undesired conveyance of the excess ink is also avoided in this exemplary embodiment.

Since, in the second exemplary embodiment, the sixth gear 26 is connected to the screen roller 9 by the freewheeling clutch 15 and the freewheeling clutch 15 freewheels during the reverse running, in this case, during this reverse running, the sixth gear 26 rotates counter to the direction of rotation 17 but not the screen roller 9, which is stationary. During the reverse running, the applicator roller 10 is set at a distance relative to the screen roller 9 but is displaced away from the latter only such that the tooth engagement existing between the sixth gear 26 and seventh gear 27 is preserved.

During printing operation, the applicator roller 10 and the seventh gear 27 rotate in the direction of rotation indicated by an arrow symbol illustrated with a continuous line (which is the clockwise direction in FIG. 2A) and the freewheeling clutch 15 locks in such a way that the rotational drive movement is transmitted from the sixth gear 26 through the freewheeling clutch 15 to the axle or shaft 18 and thus to the screen roller 9, so that the latter rotates in the duration of rotation 17 as a result.

One special feature of the second exemplary embodiment is the presence of a rider roller 14 which, during printing operation, is in rolling contact exclusively with the screen roller 9 and otherwise no other roller. A rider roller gear 29 is disposed coaxially with the rider roller 14 and connected firmly so as to rotate with the latter. The rider roller gear 29 meshes with the sixth gear 26 and is driven by the latter. During the reverse running of the printing press 1, the rider roller 14 is set at a distance relative to the screen roller 9 but which is dimensioned to be only so small that the rider roller gear 29 connected to the rider roller 14 does not come out of tooth engagement with the sixth gear 26 as a result of the distanced setting.

In non-illustrated modifications of the first and second exemplary embodiments, the freewheeling clutch 15 is replaced by a controllable clutch which is controlled in such a way that it acts like the freewheeling clutch 15.

During the printing operation mentioned in the preceding description, a printing ink different from a clear varnish, for example one of the four-color printing inks black, cyan, magenta and yellow, is printed through the use of the printing press 1. However, the printing press 1 is also suitable for printing a clear varnish which, for this purpose, is put into the ink container 3 instead of the printing ink. However, such clear varnishes, also known as printing varnishes, tend to become inhomogeneous during printing interruptions.

In order to counteract this, during a printing interruption which is used, for example, for washing the printing form cylinder 30 or for changing the printing plate clamped on the latter, it is necessary to circulate the varnish in the ink container 3 through the use of rotation of the screen roller 9 and to keep it moving.

Since, during the printing interruption, the main drive of the printing press 1 is stationary, the latter has an auxiliary electric motor 31, which is integrated through the use of a gear mechanism in a manner explained below in such a way that, during the printing interruption, although it drives the screen roller 9 in rotation, it does not drive the applicator roller 10 and the printing form cylinder 30 in rotation. During the printing interruption, the applicator roller 10 is set off the screen roller 9 but only to such an extent that the tooth engagement of the seventh gear 27 in the fifth gear 25 in the first exemplary embodiment (see FIG. 1A) or in the sixth gear 26 in the second exemplary embodiment (se FIG. 2A), is maintained.

In the first exemplary embodiment, shown in FIGS. 1A and 1B, during the printing operation, the first roller 11 and the second roller 12 are set off both from the screen roller 9 and from the third roller 13, and a motor gear 32 is mounted on a motor shaft of the auxiliary motor 31 through a further freewheeling clutch 34. The motor gear 32 meshes with the third gear 23. During the printing interruption, through the further freewheeling clutch 34, which locks as a result of the direction of rotation, the auxiliary motor 31 drives the motor gear 32, the third gear 23, the first gear 21 and, thrugh the sixth gear 26, the screen roller 9, in rotation in accordance with the direction of rotation 17. The rotational drive movement of the third gear 23 is transmitted from the latter to the fourth gear 24 as well and thus to the third roller 12 which, during the printing interruption, is corotated by the auxiliary motor 31. The first roller 11 and the second roller 12 which, during the printing operation, are driven rotationally only by circumferential rolling friction, do not rotate during the printing interruption, since they are kept out of rolling contact during the latter.

The freewheeling clutch 15 freewheels during the printing interruption, as a result of the direction of rotation, so that the rotational drive movement of the auxiliary motor 31 is not transmitted from the first gear 21 through the freewheeling clutch 15 to the second gear 22. During the printing operation, the further freewheeling clutch 34 freewheels and, as a result, prevents the rotational drive movement of the main drive from being transmitted from the motor gear 32 to the auxiliary motor 31.

In the second exemplary embodiment shown in FIGS. 2A and 2B, the motor gear 32 is seated firmly on the motor shaft of the auxiliary motor 31 so as to rotate with it, and the further freewheeling clutch 34 is disposed between the axle or shaft 18 and a further gear 33. During the printing interruption, the further freewheeling clutch 34 locks, in order to permit the transmission of the rotational drive movement of the auxiliary motor 31 from the further gear 33 to the axle or shaft 18 and, during the printing operation, freewheels in order to prevent the transmission of the rotational drive movement of the main drive from the axle or shaft 18 to the auxiliary motor 31.

In non-illustrated modifications of the first and second exemplary embodiments, the further freewheeling clutch 34 is replaced by a controllable clutch, which is controlled in such a way that it acts like the further freewheeling clutch 34.

This application claims the priority, under 35 U.S.C. §119, of German Patent Application 10 2005 019 910.0, filed Apr. 29, 2005; the entire disclosure of the prior application is incorporated herein by reference.

We claim:

1. A method for operating a printing press having a printing form cylinder and a screen roller, the method comprising the following steps:
during a continuous printing operation, rotating the printing form cylinder in a first direction of rotation and rotating the screen roller at the same time; and
during an interruption in the printing operation, rotating the printing form cylinder in a second direction of rotation and maintaining the screen roller at a rotational standstill at the same time.

2. The method according to claim 1, which further comprises keeping a metering doctor set against the screen roller during the interruption in the printing operation.

3. A printing press, comprising:
an anilox inking unit with a screen roller and a clutch integrated into said anilox inking unit, said clutch stopping rotation of said screen roller during reverse running of the printing press.

4. The printing press according to claim 3, which further comprises a gear disposed coaxially with said screen roller, said clutch connecting said screen roller to said gear.

5. The printing press according to claim 3, wherein said anilox inking unit includes a roller resting on said screen roller during a continuous printing operation, a gear coaxial with said roller, a further gear coaxial with said screen roller, and a gear mechanism interconnecting said gears, said clutch being integrated into said gear mechanism.

6. The printing press according to claim 5, wherein said gear mechanism, during forward running of the printing press, rotates said roller and said screen roller in a mutually coordinated manner causing, after each full rotation of said screen roller, a pattern being formed of fresh accumulations of printing ink applied to said roller by said screen roller to have such a slight offset in circumferential roller direction relative to just such a pattern having been applied to said roller by said screen roller during a preceding full revolution of said screen roller and being formed of accumulations of printing ink residues, that the fresh accumulations of printing ink are deliberately placed in gaps substantially free of printing ink between respective adjacent accumulations of printing ink residues on said roller.

7. The printing press according to claim 3, which further comprises an ink feed device having a single doctor resting on said screen roller.

8. The printing press according to claim 3, wherein said clutch is a freewheeling clutch.

9. The printing press according to claim 3, which further comprises a printing form cylinder, and an auxiliary motor integrated into said anilox inking unit for rotating said screen roller during rotational standstill of said printing form cylinder.

10. The printing press according to claim 9, which further comprises a further clutch integrated into said anilox inking unit, said further clutch preventing transmission of a main driving gear mechanism movement to said auxiliary motor during continuous printing operation.

11. The printing press according to claim 10, wherein said further clutch is a freewheeling clutch.

12. A printing press, comprising:
a printing form cylinder; and
an anilox inking unit for carrying out the method according to claim 1, said anilox inking unit having a screen roller and a clutch integrated into said anilox inking unit, said clutch stopping rotation of said screen roller during reverse running of the printing press.
